(19) United States
(12) Patent Application Publication
(10) Pub. No.: US 2008/0164299 A1
(43) Pub. Date: Jul. 10, 2008

(54) HEAT SINK LINER FOR WELDING TO CHROME-PLATED WORKPIECES

(76) Inventors: David Lee Pariseau, Parma, MI (US); David R. Horner, Onsted, MI (US); Mark D. Dean, Jackson, MI (US)

Correspondence Address: HARNESS, DICKEY & PIERCE, P.L.C., P.O. BOX 828, BLOOMFIELD HILLS, MI, 48303, US

(21) Appl. No.: 11/850,990

(22) Filed: Sep. 6, 2007

Related U.S. Application Data
(60) Provisional application No. 60/879,240, filed on Jan. 8, 2007.

(51) Int. Cl. B23K 31/02; F28F 7/00

(52) U.S. Cl. 228/176; 165/185; 228/222

(57) ABSTRACT

A method and apparatus for welding a first workpiece to a second workpiece having a first surface to be chrome plated welds a heat sink liner to a second surface of the second workpiece opposite the first surface. The first surface of the second workpiece is them chrome plated. The first workpiece is then welded to the second workpiece at the heat sink, which absorbs a substantial amount of heat generated by the weld before that heat can reach the chrome-plated second surface.

### CROSS REFERENCE TO RELATED APPLICATIONS

This application claims the benefit of U.S. Provisional Application No. 60/879,240 filed Jan. 8, 2007, which is hereby incorporated by reference.

### FIELD

The present disclosure relates to welding processes, and more particularly, the disclosure concerns welding to chrome-plated parts without adversely affecting the chrome finish.

### BACKGROUND

The statements in this section merely provide background information related to the present disclosure and may not constitute prior art.

Welding to a chrome-plated material is not conventionally contemplated, because the zone in the chrome-plated surface affected by welding heat usually discolors or even is destroyed, resulting in poor appearance and/or premature corrosion in the affected surface.

There is a need in the welding art for a method and apparatus for welding to a chrome-plated workpiece without adversely affecting the chromed surface.

### SUMMARY

In one aspect of the disclosed teachings, a method for welding a first workpiece to a second workpiece having a first surface to be chrome plated first welds a heat sink liner to a second surface of the second workpiece opposite the first surface. The first surface of the second workpiece is then chrome plated. The first workpiece is then welded to the second workpiece at the heat sink, which absorbs a substantial amount of heat generated by the weld before that heat can reach the chrome-plated second surface in a harmful fashion.

In another aspect of the invention, a heat sink liner is pre-welded to a workpiece at a surface opposite a workpiece surface to be chrome plated. The workpiece is then chrome plated and is ready for subsequent welding to a second workpiece at the heat sink.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWING

The drawings described herein are for illustration purposes only and are not intended to limit the scope of the present disclosure in any way.

The objects and features of the disclosed teachings will become apparent from a reading of a detailed description taken in conjunction with the drawing, in which:

FIG. 1 is an end view of a tube having an exterior chrome-plated surface and carrying an internal heat sink for welding to an internal component residing in the tube;

FIG. 2 is a cross-sectional side view of the tube and heat sink of FIG. 1;

FIG. 3 is a perspective view of the tube and heat sink of FIG. 1;

FIG. 4 is a partial cross-sectional view of an alternative tube/heat sink combination;

FIG. 5 is a cross-sectional view of the heat sink of FIGS. 1-3;

FIG. 6 is a longitudinal cross-section of a chrome-plated tube housing an alternative embodiment of a heat sink; and

FIG. 7 is a longitudinal cross-section of a chrome-plated tube housing a second alternative embodiment of a heat sink.

### DETAILED DESCRIPTION

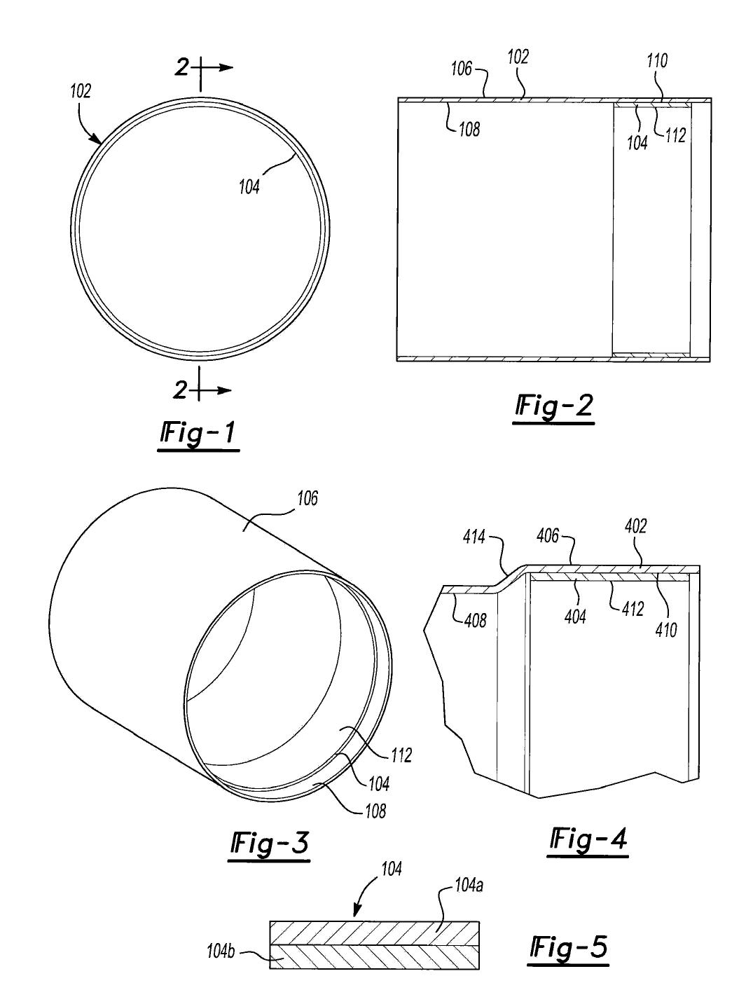

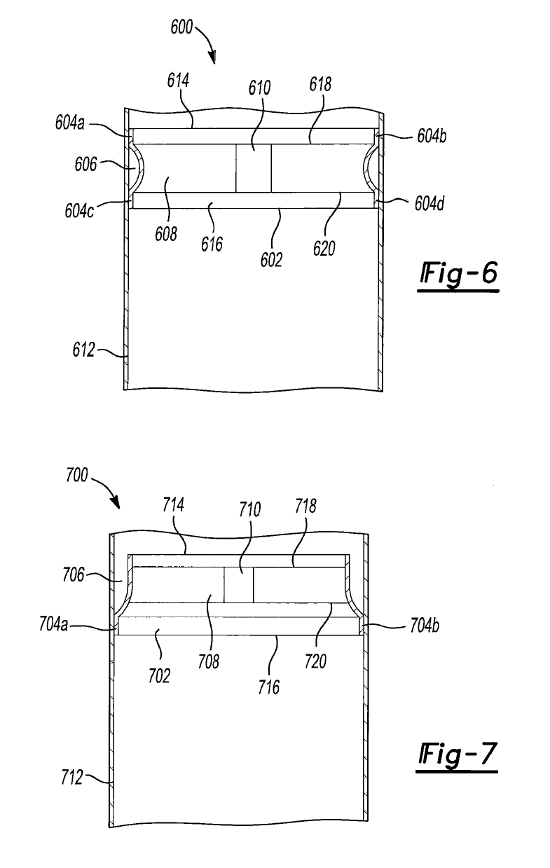

With reference to FIGS. 1-5, a tubular element 102 comprises a workpiece to be chrome plated on an exterior surface 106 thereof. In order to enable an internal component (not shown) to be welded to tube 102 without destroying or marring the chrome-plated surface 106, a heat sink element 104 is welded to an interior surface of tube 102 prior to chrome plating of exterior surface 106. Heat sink 104 preferably includes a minimum of two separate layers 104a and 104b of material that could be welded, bonded or fastened together in any manner for providing an extra material thickness to function as a heat sink for heat generated during a welding process at surface 112 of the heat sink 104.

To summarize the process used, an unplated tube 102 is first welded to a heat sink element 104 at an interior surface 108 of tube 102. Next, surface 106 of tube 102 is chrome plated. Subsequently, an interior component (not shown) may be welded to tube 102 via surface 112 of heat sink 104. Heat sink 104 is of a thickness sufficient to prevent damaging heat from reaching the chrome-plated surface 106.

The placement of the heat sink 104 is application specific and may vary for the full length of the chrome-plated workpiece 102.

It will be recognized that the shape of the chrome-plated workpiece is irrelevant for purposes of the invention. A tubular workpiece to be chrome plated is shown for the sake of example only. However, it will be understood by those skilled in the art that other shapes such as flat stock may be improved by use of the disclosure.

FIG. 4 depicts a partial cross-sectional view of an alternative chrome-plated workpiece 402 whose outer surface 414 is to be chrome plated after welding of heat sink 404 to surface 410 of tube 402. Tube 402 has a flanged exterior end for receipt of heat sink 404. An internal component will be subsequently welded to tube 402 after it has been chrome plated at surface 412 of heat sink 404.

The arrangements of FIGS. 1-5 provide for absorption by the heat sink 104 or 404 of heat generated by the final welding process prior to such heat reaching the chrome plating. This avoids discoloration of the decorative chrome surface and inhibits premature corrosion failure in the chrome plating in the vicinity of the weld area.

While it is preferred that the heat sink be comprised of two or more layers of material, a single layer of sufficient thickness may be used in appropriate applications.

With reference to FIG. 6, a first alternative embodiment of a heat sink 602 is depicted. FIG. 6 presents a longitudinal cross-sectional view of a tubular element 600 which is to be chrome plated on its exterior surface 612. Heat sink 602 includes bowed-in regions at a mid-portion of the heat sink which provide an air gap or a gap of suitable insulative material 606 between heat sink contact surfaces and the tube 600. Heat sink 602 is first welded along seams 616 and 614 to tube 600's inner surface providing contact regions 604a-d. An interior component 620 may then be welded to heat sink 602 subsequent to the chrome plating of exterior surface 612 of tube 600. For example, internal component 620 may comprise a partition having a central through aperture 610 therein. Internal component 608 is welded to heat sink 602 along seams 618 and 620. Air gap or insulative material region 606 provides further heat isolation of exterior surface 612 from heat generated by welding internal component 608 to heat sink 602.

With reference to FIG. 7 a second alternative embodiment of a heat sink is set forth in a similar tubular element 700 whose exterior surface 712 is to be chrome plated.

As seen from FIG. 7, heat sink 702 is bowed inwardly at one portion thereof to provide a separation 706 between the heat sink and the tube 700 in an area where an internal component 708 is to be welded to the heat sink 702 after surface 712 has been chrome plated. Heat sink 702 then will have areas 704a-b which are welded directly to an internal surface of tube 700. Shield 702 is additionally welded to an interior surface of tube 700 along seams 714 and 716. Internal components 708 could, for example, comprise a flange having a through hole 710. Component 708 is welded to heat sink 702 along seams 718 and 720.

The invention has been described with reference to exemplary embodiments thereof. These embodiments are not to be taken as limitations on the scope and spirit of the invention which is defined by the appropriately interpreted appended claims.

What is claimed is:

1. A method of welding a component to a chrome-plated workpiece comprising:
attaching a heat sink to the workpiece on a first surface opposite a second workpiece surface to be chrome-plated;
chrome-plating the second surface; and
welding the component to the heat sink.

2. The method of claim 1 wherein attaching the heat sink comprises welding the heat sink to the first surface.

3. The method of claim 1 wherein the workpiece comprises a tubular element having its first surface on an interior wall thereof and the second surface on an exterior wall thereof.

4. A heat sink for use in welding a component to a workpiece comprising:
a heat absorbing liner coupled to a first of the workpiece opposite a second surface of the workpiece to be chrome-plated.

5. The heat sink of claim 4 wherein the liner is comprised of at least two separate layers of heat absorbing material.

6. The heat sink of claim 4 wherein the liner is shaped so as to provide an air gap between a portion of its surface being coupled to the first surface and the first surface.

7. A method of fabricating a vehicle engine exhaust treatment device comprising:
attaching a heat sink to an interior surface of the exhaust treatment device;
chrome-plating an exterior surface of the exhaust treatment device which lies opposite the interior surface; and
welding an internal component of the exhaust treatment device to the heat sink.
